(19) United States
(12) Patent Application Publication
(10) Pub. No.: US 2025/0142003 A1
(43) Pub. Date: May 1, 2025

(54) IMAGE INSPECTION APPARATUS, IMAGE FORMING APPARATUS, IMAGE FORMING SYSTEM, IMAGE INSPECTION METHOD, AND STORAGE MEDIUM

(71) Applicant: KONICA MINOLTA, INC., Tokyo (JP)

(72) Inventor: Takashi YAMASHITA, Tokyo (JP)

(73) Assignee: KONICA MINOLTA, INC., Tokyo (JP)

(21) Appl. No.: 18/917,297

(22) Filed: Oct. 16, 2024

(30) Foreign Application Priority Data
Oct. 30, 2023 (JP) 2023-185219

(51) Int. Cl. H04N 1/00

(52) U.S. Cl. CPC H04N 1/00092; H04N 1/00005; H04N 1/0009

(57) ABSTRACT

An image inspection apparatus includes: a reader configured to read management information formed on a sheet; and a hardware processor. The hardware processor is configured to determine, by using a collation information management table that stores page numbers and collation information for the respective page numbers of sheets, whether the management information matches the collation information. The hardware processor is configured to set a start page number from which the determination is started. The hardware processor starts the determination from the start page number.

### TECHNICAL FIELD

The present invention relates to an image inspection apparatus, an image forming apparatus, an image forming system, an image inspection method, and a storage medium.

### DESCRIPTION OF THE RELATED ART

Conventionally, a real-time collation job has been executed in which first, images of character strings are formed on sheets by an image forming apparatus, then the character strings are read for respective pages by using an image inspection apparatus as a reading device connected to the image forming apparatus, and the character strings are compared (collated) with collation information in a collation information management table (Japanese Unexamined Patent Publication No. 2009-157869). Here, the collation information management table is a table that stores collation information in the order of pages.

In such real-time collation, first, character strings read from an image-formed sheet are compared with collation information corresponding to the first page in the collation information management table, and then the comparison is done in the order of pages.

At a site where an image forming apparatus is used, there is a case where a job is deleted once due to a machine trouble or the like during image formation, and the image formation is started from the N-th page of the real-time collation job, on which an image has been formed at the time of the trouble.

For another example, in a real-time collation job of 100,000 pages, there is a case where a user wants to perform image formation by dividing the job into jobs of 10,000 pages each.

In such cases as described above, the image inspection apparatus recognizes the first page of a job as the first page of the entire job. Therefore, the page number in the collation information management table does not match the page number of the sheet on which the image is formed. This causes a collation error.

For example, consider a case where images are formed for 10,000 pages each (JOB1: 1 to 10,000 pages, JOB2: 10001 to 20000 pages) as illustrated in FIG. 14, using the collation information management table for 20,000 pages in FIG. 13. Regarding JPB 1, the page number of the sheet on which the image has been formed matches the page number in the collation information management table, and “00001” is collated with “00001”. Thus, the collation is successful. However, regarding JOB2, the page number of the sheet on which the image has been formed does not match the page number in the collation information management table, and “10001” is collated with “00001”. Thus, a collation error occurs in JOB2.

### SUMMARY OF THE INVENTION

An object of the present invention is to enable collation from any page.

To achieve at least one of the abovementioned objects, according to an aspect of the present invention, image inspection apparatus reflecting one aspect of the present invention includes: a reader configured to read management information formed on a sheet; and a hardware processor configured to determine, by using a collation information management table that stores page numbers and collation information for the respective page numbers of sheets, whether the management information matches the collation information and configured to set a start page number from which the determination is started, wherein the hardware processor starts the determination from the start page number.

To achieve at least one of the abovementioned objects, according to another aspect of the present invention The present invention relates to an image forming system reflecting one aspect of the present invention includes: an image forming section configured to form an image that includes management information on a sheet; a reader configured to read the management information formed on the sheet by the image forming section; and a hardware processor configured to determine, by using a collation information management table that stores page numbers and collation information for the respective page numbers of sheets, whether the management information matches the collation information and configured to set a start page number from which the determination is started, wherein the hardware processor starts the determination from the start page number.

To achieve at least one of the abovementioned objects, according to another aspect of the present invention, there is provided an image inspection method to be executed by an image inspection apparatus that includes: a reader configured to read management information formed on a sheet; and a hardware processor configured to determine, by using a collation information management table that stores page numbers and collation information for the respective page numbers of sheets, whether the management information matches collation information and configured to set a start page number from which the determination is started, the method comprising starting the determination by the hardware processor from the start page number.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a configuration diagram of an image forming system in an embodiment of the present invention;

FIG. 2 is a block diagram illustrating a functional configuration of the image forming system;

FIG. 3 is a flow diagram of a real-time collation process;

FIG. 4 is an image diagram of a start page number setting screen;

FIG. 5 is an image diagram of a collation information management table;

FIG. 6 is an image diagram of a collation information management table;

FIG. 7 is an image diagram of a real-time collation job;

FIG. 8 is an image diagram of a collation information management table;

FIG. 9 is a flow diagram of a real-time collation process;

FIG. 10 is a flow diagram of a real-time collation process;

FIG. 11 is a diagram of a configuration of an image forming apparatus in an embodiment of the present invention;

FIG. 12 is a block diagram illustrating the functional configuration of the image forming apparatus;

FIG. 13 is an image diagram of a collation information management table; and

FIG. 14 is an image diagram of a real-time collation job.

### DETAILED DESCRIPTION

In the following, embodiments of the present invention will be described in detail with reference to the drawings. However, the scope of the invention is not limited to the illustrated examples.

### First Embodiment: Outline of Image Forming System

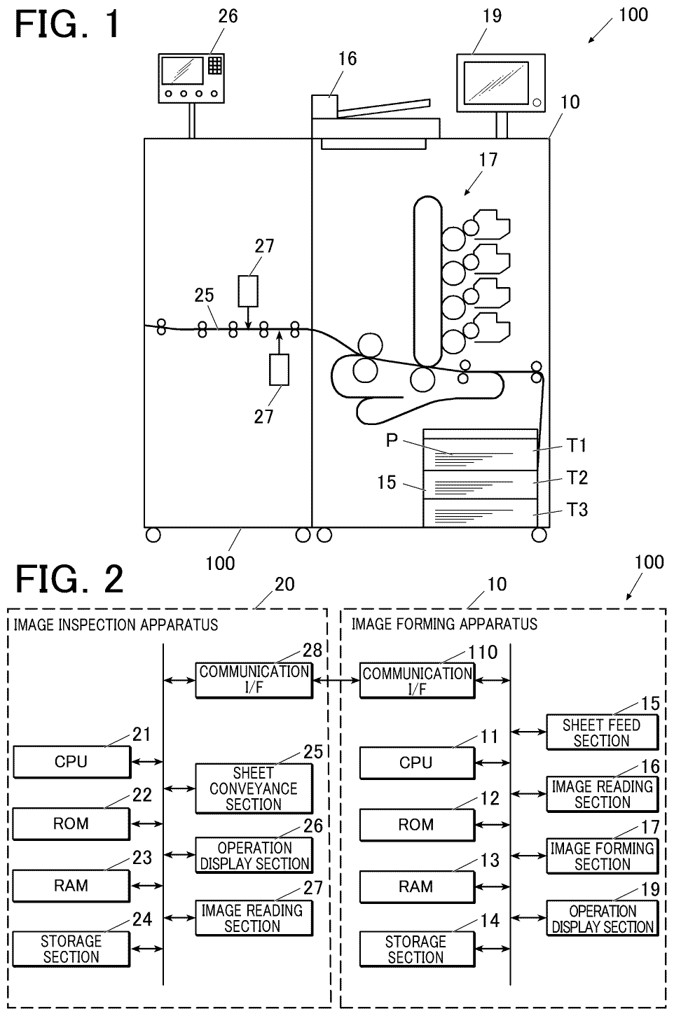

First, a configuration of an image forming system 100 will be described with reference to FIGS. 1 and 2.

FIG. 1 is a configuration diagram of the image forming system 100 according to an embodiment of the present invention. FIG. 2 is a block diagram illustrating a functional configuration of the image forming system 100.

The image forming system 100 includes an image forming apparatus 10 that performs image forming processing on sheets P and an image inspection apparatus 20 that inspects the sheets P on which image are formed by the image forming apparatus 10.

### [Image Forming Apparatus]

The image forming apparatus 10 forms images on sheets P in accordance with image forming instructions received from an information processing terminal, such as an external personal computer (PC), via a communication network. The image forming apparatus 10 conveys the sheet P after image formation to the image inspection apparatus 20.

The image forming apparatus 10 includes a CPU 11, a read only memory (ROM) 12, a Random Access Memory (RAM) 13, a storage section 14, a sheet feed section 15, an image reading section 16, an image forming section 17, an operation display part 19, and a communication Interface (I/F) 110.

The CPU 11 reads a program stored in the ROM 12, loads the program in the RAM 13, and controls operations of components constituting the image forming apparatus 10 in cooperation with the deployed program.

The ROM 12 is constituted of a non-volatile memory, for example and stores a system program, various processing programs executable on the system program, various kinds of data, and so forth.

The RAM 13 is composed of a volatile semiconductor memory, for example. The RAM 13 forms a work area for temporarily storing programs read from the ROM 12, input or output data, parameters and the like in various kinds of processing executed by the CPU 11.

The storage section 14 includes a hard disk drive (HDD) and a non-volatile semiconductor memory, and stores various types of data.

The sheet feed section 15 includes a plurality of sheet feed trays T1 to T3 that can store sheets P of different sizes, types (paper types), basis weights, and the like. The sheet feed section 15 feeds the sheets P stored in the set sheet feed trays T1 to T3 to the image forming section 17.

The image reading section 16 reads documents and generates image data. Specifically, the image reading section 16 reads, with a charge coupled device (CCD) image sensor or the like, light emitted from a light source and reflected by the document.

The image forming section 17 forms images on the sheets P. The image forming section 17 charges a photoreceptor with a charging section, forms an electrostatic latent image by exposing and scanning the photoreceptor with a laser beam emitted from an exposure section based on image data, develops the electrostatic latent image with toner by a developing section, transfers the toner image onto the sheet P by a transfer section, and fixes the toner image onto the sheet P by a fixing section (fixing device).

The operation display part 19 includes a display section that is configured by a liquid crystal display (LCD) to display various screens, and an operation part constituted of a touch screen superimposed on the display section and various keys. The operation display part 19 outputs an operation signal input by a touch operation or a key operation to the central processing unit (CPU) 11.

The communication I/F 110 is constituted of a network interface card (NIC), a modem, or the like, and transmits and receives data to and from the image inspection apparatus 20, a personal computer (PC), or the like.

### [Image Inspection Apparatus]

The image inspection apparatus 20 reads, for each page, management information formed as an image in a predetermined area of a sheet P; acquires, in real time, collation information corresponding to the page number from a collation information management table that stores collation information for the respective page numbers; and compares (collates) the management information with the collation information. Thus, the image inspection apparatus 20 inspects the sheets P (real-time collation process).

The management information and the collation information are, for example, numbers, character strings, and symbols.

The image inspection apparatus 20 includes a CPU 21, a ROM 22, a RAM 23, a storage section 24, a sheet conveyance section 25, an operation display section 26, an image reading section 27, a communication I/F 28, and the like.

The CPU 21, the ROM 22, and the RAM 23 are the same as the CPU 11, the ROM12, and the RAM 13 except that the control target of the CPU 21 is the image inspection apparatus 20.

The CPU 21 functions as a determining unit that determines whether the management information matches the collation information by using a collation information management table that stores page numbers and the collation information for the respective page numbers of the sheets.

The CPU 21 functions as a setting unit that sets a start page number from which the determination starts. The CPU 21 may set start management information or start collation information from which the determination starts.

The storage section 24 is constituted of an HDD and/or a nonvolatile semiconductor memory and stores various types of data, such as the collation information management table.

The sheet conveyance section 25 is composed of a plurality of conveyance rollers provided along a conveyance path and conveys the sheets P transported from the image forming apparatus 10.

The operation display section 26 includes a display part constituted of an LCD and configured to display various screens and an operation part constituted of a touch screen laid on the display part and various keys. The operation display section 26 outputs an operation signal input by a touch operation or a key operation to the CPU 21.

The communication I/F 28 is constituted of an NIC, a modem, or the like, and sends and receives data to and from the image forming apparatus 10, PCs, and the like.

The image reading section 27 reads sheets P transported from the image forming apparatus 10 and generates image data. The image reading section 27 can read both sides of a sheet P. Specifically, the image reading section 27 reads, with a charge coupled device (CCD) image sensor or the like, light emitted from a light source and reflected by a document.

The image reading section 27 functions as a reader that reads management information formed on sheets. The image reading section 27 not only reads the sheets P but also detects abnormalities such as stains, streaks, black/white dots, and an alignment error with a reference image.

### [Case 1: Real-Time Collation Process]

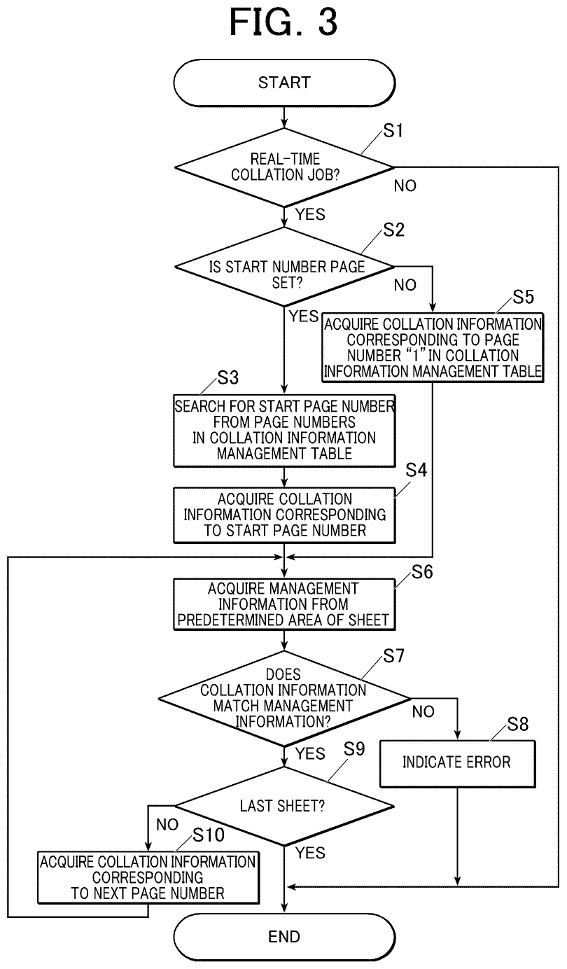

With reference to FIG. 3, the flow of the real-time collation process by the CPU 21 will be described. The real-time collation process is started, for example, when the CPU 21 acquires job information.

Concurrently with the real-time collation process, the image forming apparatus 10 forms images of the management information in a predetermined area of the sheets P for the respective pages.

The collation information management table (FIG. 5 and FIG. 6), which is used in the real-time collation process, have been sent to the image inspection apparatus 20 beforehand from an information processing terminal, such as an external PC.

First, upon receiving job information, the CPU 21 determines whether the job information is related to a real-time collation job or not (step S1).

When determining that the job information is related to a real-time collation job (step S1; YES), the CPU 21 proceeds to step S2.

When the job information is not related to a real-time collation job (step S1; NO), the CPU 21 ends the real-time collation process.

Next, the CPU 21 determines whether or not the start page number has been set in the real-time collation process (step S2).

When determining that the start page number has been set in the real-time collation process (step S2; YES), the CPU 21 acquires the start page number and proceeds to step S3.

If the start page number has not been set in the real-time collation process (step S2; NO), the CPU 21 proceeds to step S5.

Here, a method for setting the start page number will be described.

Regarding the method for setting the start page number, there are cases (i) where the start page number is set by an information processing terminal, such as an external PC, (ii) where the start page number is set by the image inspection apparatus 20, and (iii) where the start page number is added to the collation information management table.

In performing the real-time collation, the start page number is set before the real-time collation job (before step S2 at the latest).

Following is the description on (i) the case where the start page number is set by an information processing terminal, such as an external PC, and (ii) the case where the start page number is set by the image inspection apparatus 20.

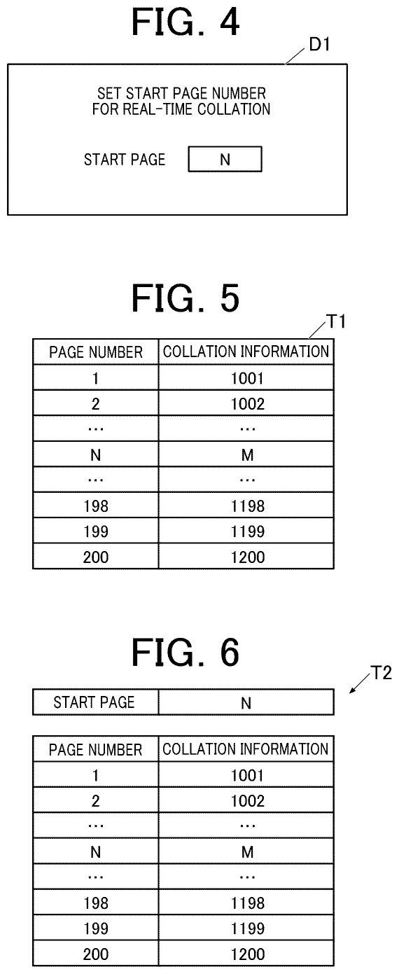

The user inputs the start page number (N) on a display part of an information processing terminal, such as an external PC, or on a start page number setting screen D1 (illustrated in FIG. 4) of the operation display section 26 of the image inspection apparatus 20. The CPU 21 acquires the input start page number.

The start page number setting screen D1 illustrated in FIG. 4 is an interface for directly inputting the start page number. However, various interfaces are conceivable, such as an interface that allows the user to select a page number by pull-down.

Following is the description on the case where the start page number is added to the collation information management table.

As shown in FIG. 6, the collation information management table is attached with the start page number (N) and is transmitted from an information processing terminal, such as an external PC, to the image inspection apparatus 20. The CPU 21 acquires the start page number from the collation information management table. The real-time collation process is described in the following.

The CPU 21 searches for the start page number (N) from the page numbers in the collation information management table (FIG. 5 or FIG. 6) (step S3).

Next, the CPU 21 acquires the collation information (M) corresponding to the page number that matches the start page number (N) from the collation information management table (FIG. 5 or FIG. 6) (step S4).

In Step S5, the image inspection apparatus 20 acquires the collation information (1001) corresponding to the page number (1) in the collation information management table (FIG. 5 or FIG. 6) (step S5).

Next, the CPU 21 causes the image reading section 27 to read the conveyed sheet P and to read the management information from a predetermined region of the sheet P. The CPU 21 acquires the management information from the image reading section 27 (step S6).

Next, the CPU 21 determines whether the collation information acquired in step S4 or step S5 matches the management information acquired in step S6 (step S7).

When determining that the collation information acquired in step S4 or step S5 matches the management information acquired in step S6 (step S7: YES), the CPU 21 proceeds to step S9.

When determining that the collation information acquired in step S4 or step S5 does not match the management information acquired in step S6 (step S7; NO), the CPU 21 proceeds to step S8.

In a case where there is an abnormality in reading by the image reading section 27 in step S6 and CPU 21 cannot acquire the management information, the CPU 21 determines that the collation information acquired in step S4 or step S5 does not match the management information acquired in step S6 (step S7; NO). For example, there is a case where the management information formed by the image forming apparatus 10 in a predetermined area of the sheet P has a problem. For example, the management information may include a missing part or a blur, or the management information may be formed outside the predetermined area of the sheet P.

Next, the CPU 21 shows an error on the operation display section 26 (step S8).

Next, the CPU 21 determines whether this sheet is the last sheet (step S9).

When determining that this sheet is not the last sheet (step S9; NO), the CPU 21 proceeds to step S10.

When determining that this sheet is the last sheet (step S9; YES), CPU 21 ends the real-time collation process.

Next, the CPU 21 acquires collation information corresponding to the next page number in the collation information management table (step S10).

After the acquisition in Step S10, the CPU 21 proceeds to step S6 and reads management information of the next sheet on which an image has been formed and which has been conveyed.

Thus, it is possible to set the start page number from which the real-time collation is resumed before starting each of the jobs, in a case where the user wants to resume a job from the middle of the job after stopping or deleting the job or in a case where the user wants to divide a job into multiple jobs and execute the multiple jobs. Thus, the work of re-creating and re-transmitting the collation information management table is eliminated.

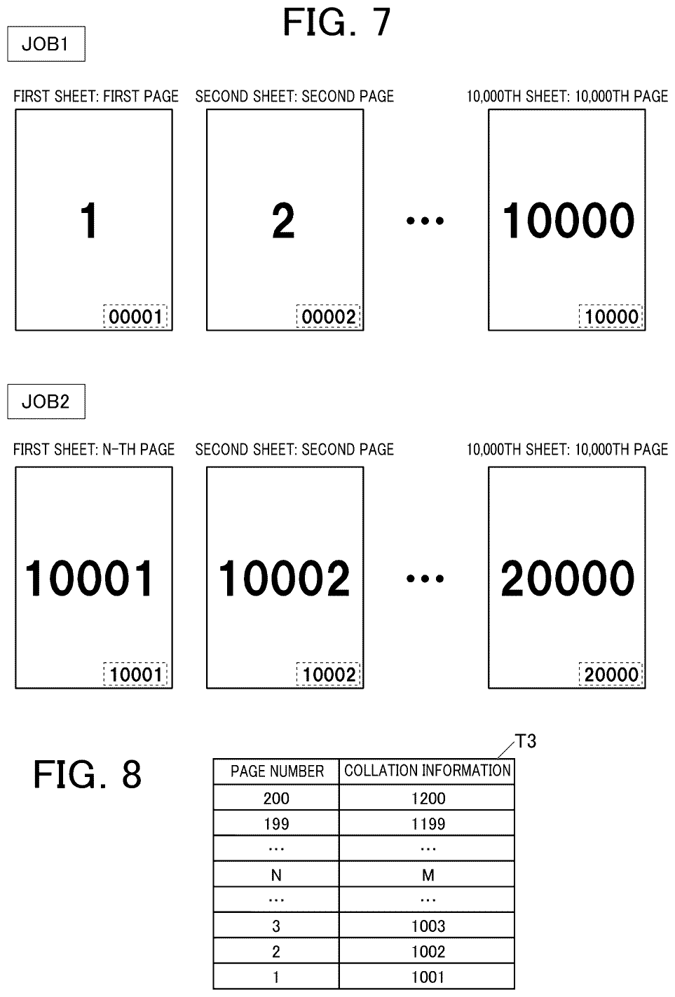

The details of the real-time collation job are described with reference to an image diagram of the real-time collation job in FIG. 7. JOB1 is a job to be executed first. JOB2 is a job from which the real-time collation job is resumed. Before JOB2 starts, the start page number (N) is set, so that the page number of the first sheet of JOB2 is set to N.

In the case 1, the CPU 21 checks the next page number in step S10. Therefore, the sheets P needs to be conveyed in order.

Further, since the CPU 21 searches for collation information in the collation information management table using a page number as a key, the sets of a page number and collation information may not be arranged in the order of the page numbers. For example, the sets of a page number and collation information may be arranged in descending order of page numbers as illustrated in FIG. 8, or may be arranged in random order.

In the above description, the start page number has been set in step S2. Instead, management information (start management information) or collation information (start collation information) from which the determination starts may have been set in Step S2. In a case where the start management information or the start collation information is set, the CPU 21 searches the collation information management table for the page number corresponding to the start management information or the start collation information. The CPU 21 then acquires the found page number as the start page number.

### [Case 2: Real-Time Collation Process]

In the case 1, the start page number is set by the user's operation. In the case 2, the CPU 21 uses the document page number included in the job information as the start page number.

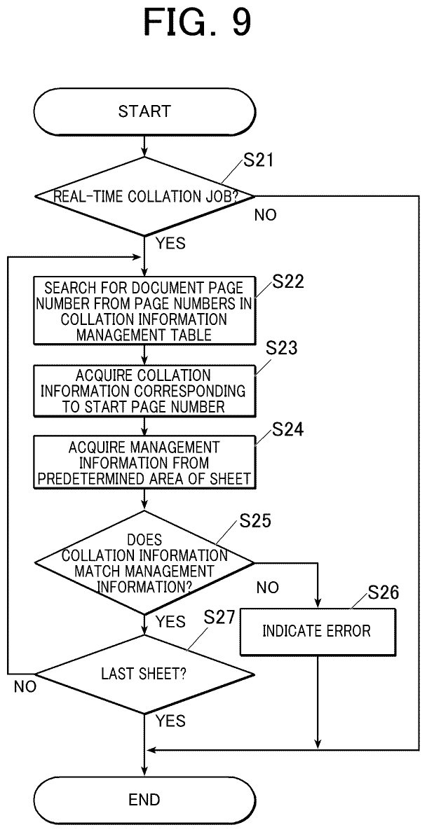

The flow of the real-time collation process by the CPU 21 will be described with reference to FIG. 9. The process other than steps S22 and S27 described below is the same as the process of the case 1 except that “the start page number” is replaced with “the document page number”.

The CPU 21 acquires the document page number included in the job information and searches for the document page number (N) in the page numbers in the collation information management table (step S22).

The CPU 21 determines whether the sheet is the last sheet (step S27).

When determining that the sheet is not the last sheet (step S27; NO), CPU 21 proceeds to step S22.

When determining that the sheet is the last sheet (step S27; YES), CPU 21 ends the real-time collation process.

Thus, the document page number included in the job information at the time of resuming the job is automatically set as the start page number, in a case where the user wants to resume a job from the middle of the job after stopping or deleting the job or in a case where the user wants to divide a job into multiple jobs and execute the multiple jobs. Thus, the work of re-creating and re-transmitting the collation information management table is eliminated.

Further, the sheets P need not be conveyed in order, and the user does not have to pay attention to the conveyance order of the sheets P.

### [Case 3: Real-Time Collation Process]

In the case 3, if the management information read from the conveyed first sheet P is included in the collation information on the collation information management table, the page number corresponding to the collation information is used as the start page number.

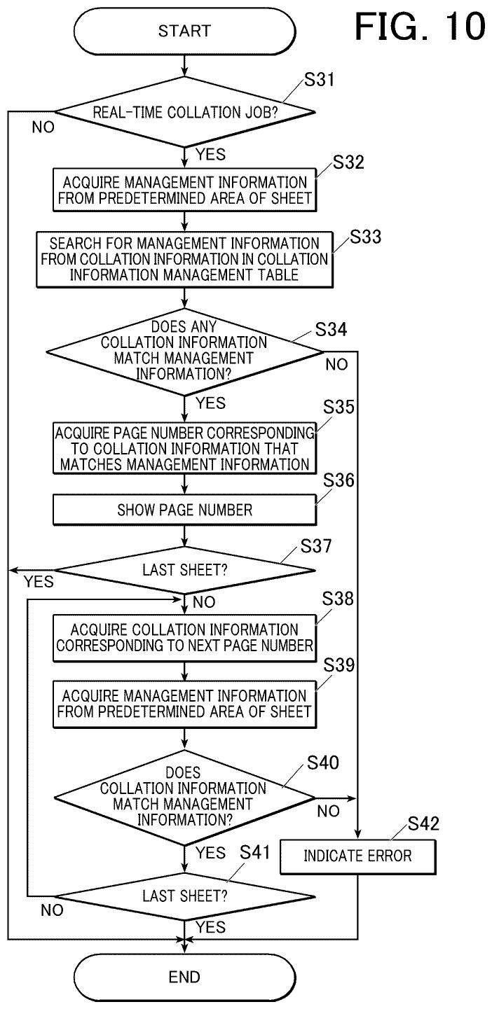

A flow of the real-time collation process by the CPU 21 will be described with reference to FIG. 10. The process other than steps S32 to S37 described below is the same as the process of the case 1.

The CPU 21 causes the image reading section 27 to read the conveyed sheet P and to read the management information from a predetermined area of the sheet P (step S32). The CPU 21 acquires the management information (M) from the image reading section 27.

Next, the CPU 21 searches for the management information (M) from the collation information in the collation information management table (FIGS. 5 and 6) (step S33).

In Step S33, when finding collation information that matches the management information (M) (step S34; YES), the CPU 21 proceeds to step S35.

In Step S33, when the CPU 21 does not find collation information that matches the management information (M) (step S34; NO), the CPU 21 proceeds to step S42.

Next, the CPU 21 acquires, from the collation information management table (FIGS. 5 and 6), the page number (N) corresponding to the collation information that matches the management information (M) (step S35).

Next, the CPU 21 causes a display part, such as the operation display section 26, to show a warning of the page number (N) and the collation information (M) (step S36). The CPU then proceeds to step S37.

In addition to the above, the CPU 21 may temporarily stop the real-time collation process and cause the operation display section 26 to show a pop-up asking the user whether to continue the real-time collation process. When the user inputs an instruction to continue the process in the pop-up, the CPU 21 continues the real-time collation process.

In a case where the job is interrupted and resumed without being deleted, the job is re-executed from a sheet P next to the sheet P for which the collation has been completed at the time of resumption. Therefore, step S36 may not be executed. The case where the job is interrupted and resumed without being deleted is, for example, a case where the job is interrupted by lack of paper or paper jam.

Next, the CPU 21 determines whether the sheet is the last sheet (step S37).

When determining that the sheet is not the last sheet (step S37; NO), the CPU 21 proceeds to step S38.

When determining that the sheet is the last sheet (step S37; YES), CPU 21 ends the real-time collation process.

Thus, the page number searched based on the management information read from the first sheet P that is firstly conveyed when resuming the job is automatically set as the start page number, in a case where the user wants to resume the job from the middle of the job after stopping or deleting the job or in a case where the user wants to divide a job into multiple jobs and execute the multiple jobs. Thus, the work of re-creating and re-transmitting the collation information management table is eliminated.

### Second Embodiment: Outline of Image Forming Apparatus

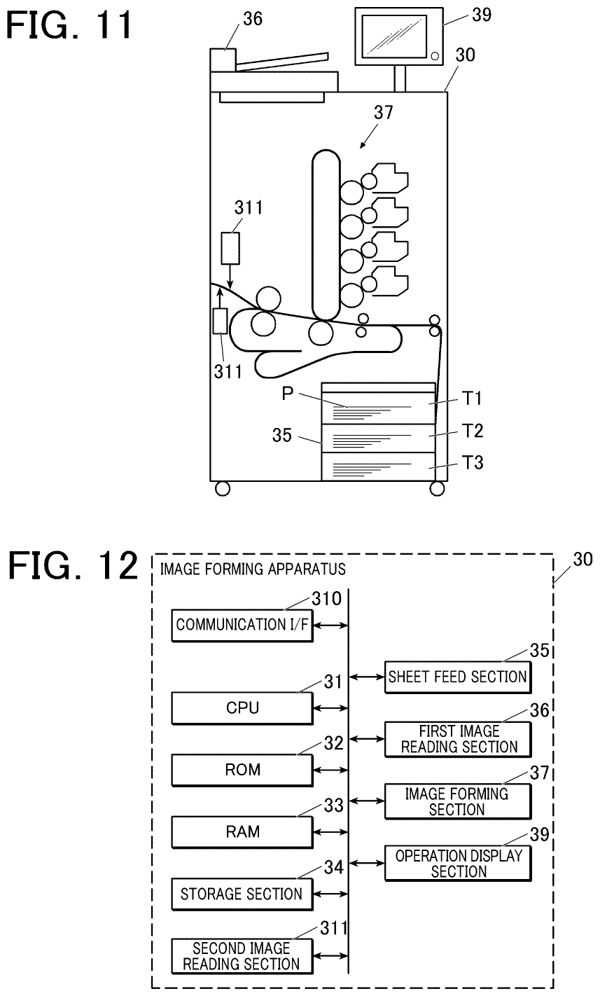

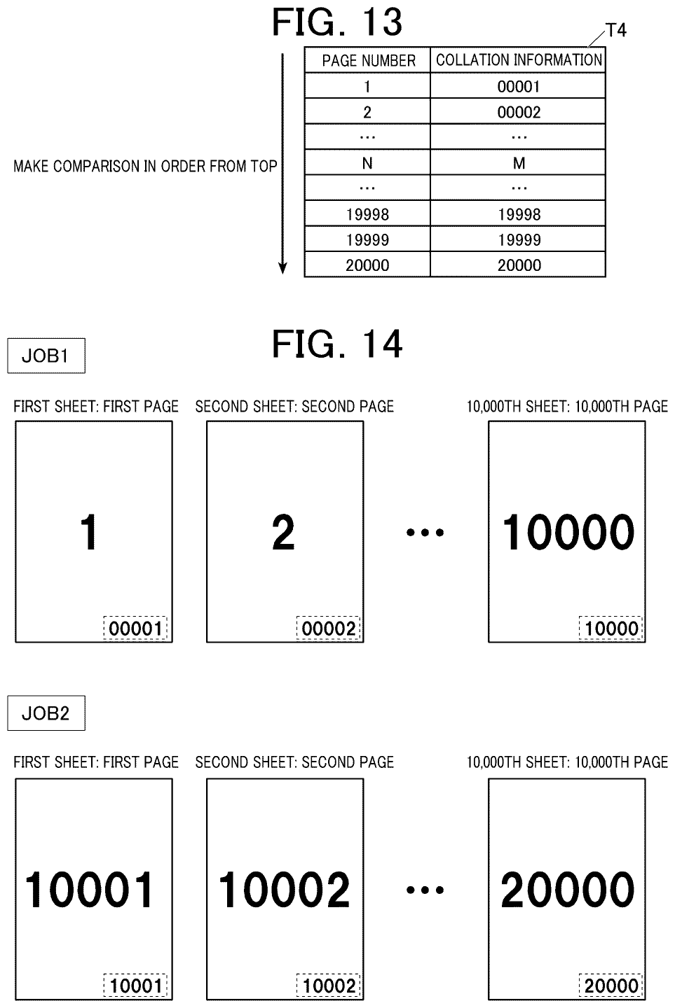

A configuration of an image forming apparatus 30 is described with reference to FIGS. 11 and 12.

FIG. 11 shows a configuration of the image forming apparatus 30 in the second embodiment of the present invention. FIG. 12 is a block diagram illustrating a functional configuration of the image forming apparatus 30.

The image forming apparatus 30 includes the configuration of the image forming apparatus 10 and the configuration corresponding to the image reading section 27 of the image inspection apparatus 20 in the first embodiment.

In the image forming apparatus 30, a configuration corresponding to the image reading section 16 of the image forming apparatus 10 in the first embodiment is referred to as a first image reading section 36; and a configuration corresponding to the image reading section 27 of the image inspection apparatus 20 in the first embodiment is referred to as a second image reading section 311.

The components of the image forming apparatus 30, such as the CPU 31, have the configuration of the corresponding components of the image forming apparatus 10 and the image inspection apparatus 20.

In the second embodiment, the real-time collation process is executed by the CPU 31, and the components in the real-time collation process of the first embodiment are replaced with the corresponding components of the image forming apparatus 30.

### [Effects]

As described above, the image inspection apparatus 20 includes the reader (image reading section 27) that reads management information formed on the sheet. The image inspection apparatus 20 further includes the CPU 21 that determines whether the management information matches the collation information by using the collation information management table that stores page numbers and collation information for the respective page numbers of sheets. Further, the CPU 21 of the image inspection apparatus 20 sets a start page number from which the determination starts. The CPU 21 starts the determination from the start page number.

Therefore, collation can be started from any page.

Further, when a print job is interrupted, the CPU 21 sets a page number in the middle of the print job as a start page number from which the determination is resumed.

Therefore, collation can be started from any page.

The CPU 21 also searches for the start page number from the page numbers in the collation information management table.

Further, the CPU 21 searches for the management information from the collation information in the collation information management table.

Therefore, collation can be started from any page.

Further, the image forming apparatus 30 includes the image forming section 37 that forms an image including management information on a sheet. Further, the image forming apparatus 30 includes the reader (second image reading section 311) that reads the management information formed on the sheet by the image forming section. Further, the image forming apparatus 30 includes the CPU 31 that determines whether the management information matches the collation information by using the collation information management table that stores page numbers and collation information for the respective page numbers of sheets. Further, the CPU 31 of the image forming apparatus 30 sets a start page number from which the determination is started. The CPU 31 starts the determination from the start page number.

Therefore, collation can be started from any page.

Further, the image forming system 100 includes the image forming section 17 that forms an image including management information on a sheet. Further, the image forming system 100 includes the reader (image reading section 27) that reads the management information formed on the sheet by the image forming section. Further, the image forming system 100 includes the CPU 21 that determines whether the management information matches the collation information by using the collation information management table that stores page numbers and collation information for the respective page numbers of sheets. Further, the CPU 21 of the image forming system 100 sets a start page number from which the determination is started. The CPU 31 starts the determination from the start page number.

Therefore, collation can be started from any page.

Further, the image inspection method is executed by the image inspection apparatus 20 including: the reader (the image reading section 27) that reads management information formed on a sheet; and the CPU 21 that determines whether the management information matches the collation information by using the collation information management table that stores page numbers and collation information for the respective page numbers of sheets and that sets a start page number from which the determination is started. The method includes determining, by the CPU 21, whether the management information matches the collation information from the start page number.

Therefore, collation can be started from any page.

Furthermore, the program is for a computer of the image inspection apparatus 20 including: the reader (the image reading section 27) that reads management information formed on a sheet; and the CPU 21 that determines whether the management information matches the collation information by using the collation information management table that stores page numbers and collation information for the respective page numbers of sheets and that sets a start page number from which the determination is started.

The program causes the computer to determine whether the management information matches the collation information from the start page number.

Therefore, collation can be started from any page.

### [Others]

The embodiments described above are examples of the image inspection apparatus and the image forming system according to the present invention and are not intended to limit the present invention. The detailed configuration and detailed operation of the components constituting the apparatuses can be changed as appropriate without departing from the scope of the present invention.

The CPU 21, the ROM 22, the RAM 23, the storage section 24, and the operation display section 26 of the image inspection apparatus 20 may be shared with the CPU 11, the ROM 12, the RAM 13, the storage section 14, and the operation display part 19 of the image forming apparatus 10. The real-time collation process may be executed by the shared configuration.

The image forming apparatus 10 or the image inspection apparatus 20 may be connected to an information processing terminal, such as an external personal computer, and the information processing terminal may perform the above-described process of the CPU 21 of the image inspection apparatus 20. Further, various parameters for cutting may be input through an input interface such as a keyboard or a mouse provided to an information processing terminal, such as a personal computer.

In this case, a configuration including the information processing terminal, such as a personal computer, may be regarded as the image forming system.

Furthermore, although the paper sheets P are used as sheets in the above-described embodiments, material of the sheets is not limited to paper but may be sheet-like resin, for example.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2023-185129 filed on Oct. 30, 2023 is incorporated herein by reference in its entirety.

1. An image inspection apparatus comprising:
a reader configured to read management information formed on a sheet; and
a hardware processor configured to determine, by using a collation information management table that stores page numbers and collation information for the respective page numbers of sheets, whether the management information matches the collation information and configured to set a start page number from which the determination is started,
wherein the hardware processor starts the determination from the start page number.

2. The image inspection apparatus according to claim 1, wherein in a situation that the reader is not able to read the management information, the hardware processor determines that the management information does not match the collation information.

3. The image inspection apparatus according to claim 1, wherein in a situation that a print job is interrupted, the hardware processor determines a page number at which the print job is interrupted to be the start page number from which the determination is resumed.

4. The image inspection apparatus according to claim 1, wherein the hardware processor searches for the start page number from the page numbers in the collation information management table.

5. The image inspection apparatus according to claim 1, wherein the hardware processor searches for the management information from the collation information in the collation information management table.

6. An image forming apparatus comprising:
the image inspection apparatus according to claim 1; and
an image forming section configured to form an image including the management information on a sheet.

7. An image forming system comprising:
an image forming section configured to form an image that includes management information on a sheet;
a reader configured to read the management information formed on the sheet by the image forming section; and
a hardware processor configured to determine, by using a collation information management table that stores page numbers and collation information for the respective page numbers of sheets, whether the management information matches the collation information and configured to set a start page number from which the determination is started,
wherein the hardware processor starts the determination from the start page number.

8. An image inspection method to be executed by an image inspection apparatus that includes:
a reader configured to read management information formed on a sheet; and
a hardware processor configured to determine, by using a collation information management table that stores page numbers and collation information for the respective page numbers of sheets, whether the management information matches collation information and configured to set a start page number from which the determination is started,
the method comprising starting the determination by the hardware processor from the start page number.

9. A non-transitory computer-readable storage medium storing a program for a computer of an image inspection apparatus that includes a reader configured to read management information formed on a sheet, the program causing the computer to perform the image inspection method according to claim 8.
